(19) United States
(12) Patent Application Publication
(10) Pub. No.: US 2015/0308475 A1
(43) Pub. Date: Oct. 29, 2015

(54) Quick connecting structure

(71) Applicant: Chou, Yu Hsiang, Taichung City (TW)

(72) Inventor: Chou, Yu Hsiang, Taichung City (TW)

(21) Appl. No.: 14/260,298

(22) Filed: Apr. 24, 2014

(51) Int. Cl. F16B 7/04

(52) U.S. Cl. CPC F16B 7/044

(57) ABSTRACT

A quick connecting structure contains a plurality of longitudinal parts, plural connectors, and a plurality of horizontal parts. Each longitudinal part includes two first retaining slots, each being formed in a dovetail shape and having a plurality of positioning holes. Each connector is formed in a dovetail shape to correspond to each longitudinal part and includes a second retaining slot formed in a dovetail shape, two parallel recesses, a fixing portion defined between the two parallel recesses, two flexible moving portions, and two coupling segments for coupling the fixing portion and the two flexible moving portions, the fixing portion has plural posts retaining with the plurality of positioning holes. Each horizontal part includes two engaging blocks, and each engaging block has an insertion and an engagement seat joining with the insertion, wherein the engagement seat is formed in a dovetail shape to correspond to the second retaining slot.

### FIELD OF THE INVENTION

The present invention relates to a quick connecting structure which can connect plural rectangular frames quickly and easily by means of a plurality of longitudinal connecting parts, plural connectors, and a plurality of horizontal parts.

### BACKGROUND OF THE INVENTION

A conventional rectangular frame contains plural longitudinal parts and a plurality of horizontal parts which are connected together by plural screw bolts and nuts. However, a plurality of orifices have to be drilled on each longitudinal part and each horizontal parts so as to screw with the plural screw bolts and nuts, thus causing high production cost and complicated assembly.

The present invention has arisen to mitigate and/or obviate the afore-described disadvantages.

### SUMMARY OF THE INVENTION

The primary object of the present invention is to provide a quick connecting structure which can connect plural rectangular frames quickly and easily by means of a plurality of longitudinal connecting parts, plural connectors, and a plurality of horizontal parts.

To obtain the above objective, a quick connecting structure provided by the present invention contains: a plurality of longitudinal connecting parts, plural connectors, and a plurality of horizontal parts.

Each longitudinal part includes two symmetrical side surfaces on which two first retaining slots are defined, each first retaining slot is formed in a dovetail shape and has a plurality of positioning holes equidistantly formed thereon.

Each connector is formed in a dovetail shape to correspond to each longitudinal part and includes a second retaining slot formed on a front surface thereof and in a dovetail shape, two parallel recesses defined on a rear surface thereof, a fixing portion defined between the two parallel recesses, two flexible moving portions formed on two sides thereof, and two coupling segments for coupling the fixing portion and the two flexible moving portions, the fixing portion has plural posts for retaining with the plurality of positioning holes.

Each horizontal part includes two engaging blocks retained in two sides thereof, and each engaging block has an insertion extending from one side thereof and an engagement seat joining with the insertion, wherein the engagement seat is formed in a dovetail shape to correspond to the second retaining slot.

### BRIEF DESCRIPTION OF THE DRAWINGS

FIG. 1 is a perspective view showing the exploded components of a quick connecting structure according to a preferred embodiment of the present invention.

FIG. 2 is a perspective view showing the assembly a connector of the quick connecting structure according to the preferred embodiment of the present invention.

FIG. 3 is a plane view showing the assembly of the quick connecting structure according to the preferred embodiment of the present invention.

FIG. 4 is a perspective view showing the assembly of the quick connecting structure according to the preferred embodiment of the present invention.

FIG. 5 is another perspective view showing the assembly of the quick connecting structure according to the preferred embodiment of the present invention.

FIG. 6 is a perspective view showing the application of the quick connecting structure according to the preferred embodiment of the present invention.

FIG. 7 is a perspective view showing the application of the quick connecting structure according to the preferred embodiment of the present invention.

### DETAILED DESCRIPTION OF THE PREFERRED EMBODIMENTS

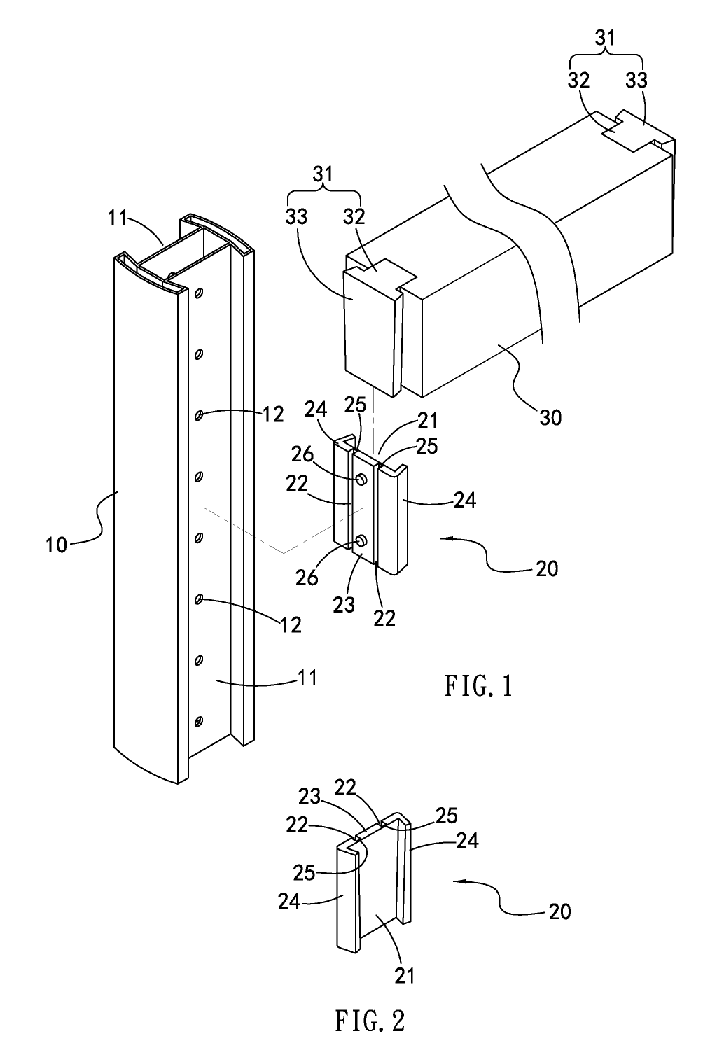

With reference to FIGS. 1-4, a quick connecting structure according to a preferred embodiment of the present invention comprises: a plurality of longitudinal connecting parts 10, plural connectors 20, and a plurality of horizontal parts 30.

Each longitudinal part 10 is a hollow column and is extruded from aluminum material. Each longitudinal part 10 includes a rectangular cross section, two opposite arcuate surfaces, and two symmetrical side surfaces on which two first retaining slots 11 are defined. Each first retaining slot 11 is formed in a dovetail shape and has a plurality of positioning holes 12 equidistantly formed thereon.

Each connector 20 is made of plastic material and is formed in a dovetail shape to correspond to each longitudinal part 10. Each connector 20 includes a second retaining slot 21 formed on a front surface thereof and in a dovetail shape, two parallel recesses 22 defined on a rear surface thereof, a fixing portion 23 defined between the two parallel recesses 22, two flexible moving portions 24 formed on two sides thereof, and two coupling segments 25 for coupling the fixing portion 23 and the two flexible moving portions 24. The fixing portion 23 has plural posts 26 for retaining with the plurality of positioning holes 12 to prevent each connector 20 from moving in the each first retaining slot 11. The two flexible moving portions 24 are pressed to move each connector 20 into or out of each first retaining slot 11.

Each horizontal part 30 includes two engaging blocks 31 retained in two sides thereof, and each engaging block 31 has an insertion 32 extending from one side thereof and an engagement seat 33 joining with the insertion 32. The engagement seat 33 is formed in a dovetail shape to correspond to the second retaining slot 21.

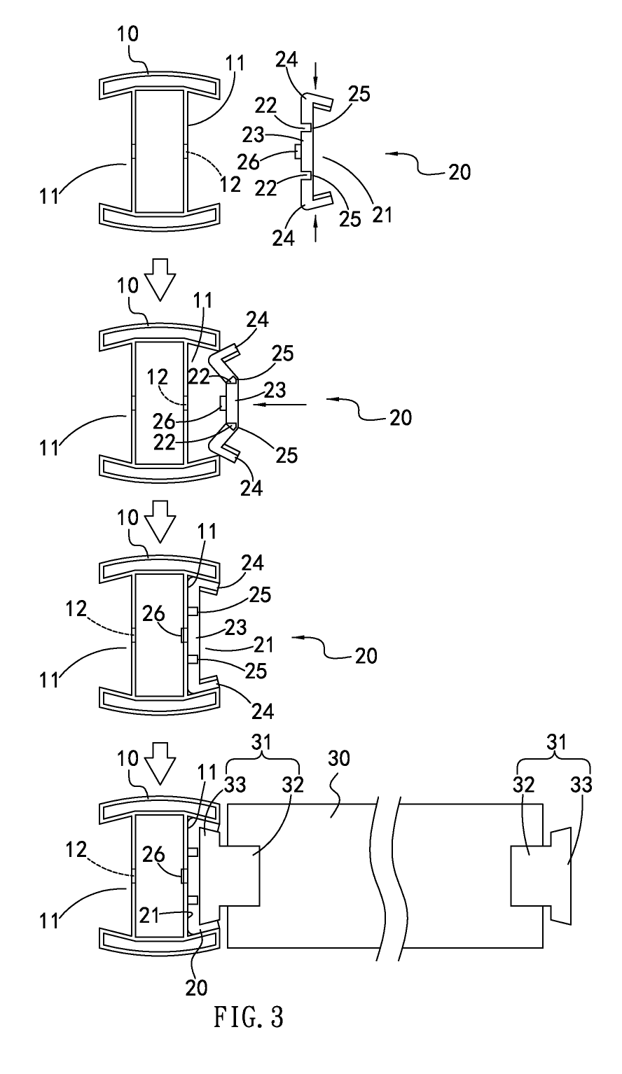

Referring to FIG. 3, the two flexible moving portions 24 of each connector 20 are pressed relative to the fixing portion 23 and swing backwardly to an angle so that each connector 20 is pressed into each first retaining slot 11 of each longitudinal part 10, and the plural posts 26 retain with the plurality of positioning holes 12. Thereafter, each engaging block 31 is placed into the each connector 20 so that the engagement seat 33 of each engaging blocks 31 is engaged in the second retaining slot 21 of each connector 20, thus retaining each horizontal part 30 with each longitudinal part 10. In contrast, each engaging block 31 of each horizontal part 30 is pushed upwardly so that the engagement seat 33 of each engaging block 31 disengages from the second retaining slot 21 of each connector 20, thereby removing each horizontal part 30 from each longitudinal part 10. Thereafter, a hand tool, such as a flathead screwdriver, is inserted and rotated in each first retaining slot 11 so that the two flexible moving portions 24 of each connector 20 swing and the two coupling segments 25 deform, thus removing each connector 20 from each first retaining slot 11 easily. Accordingly, each horizontal part 30 is fixed in one of the two symmetrical side surfaces of each longitudinal part 10 by retaining each connector 20 in one of the two first retaining slots 11.

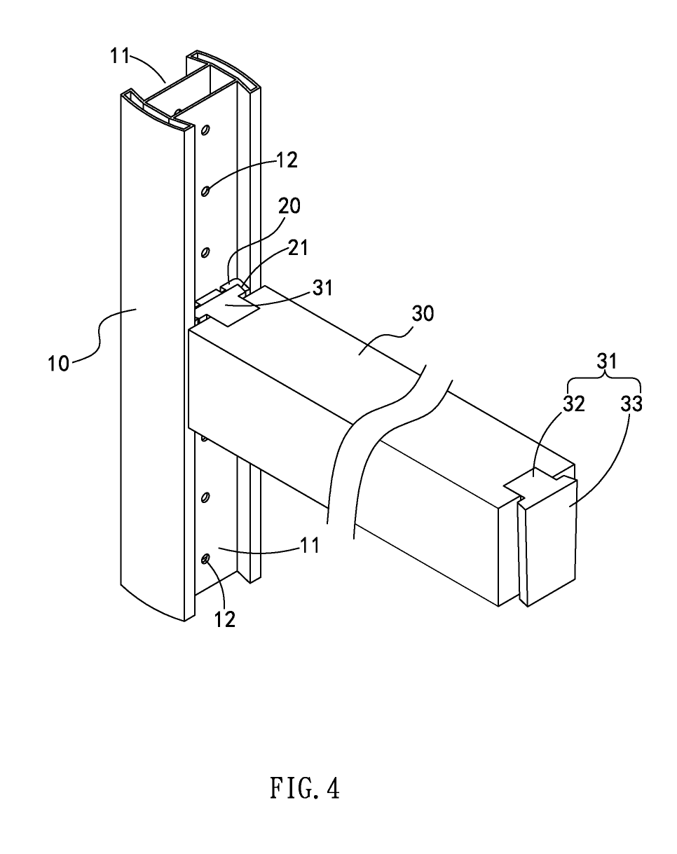

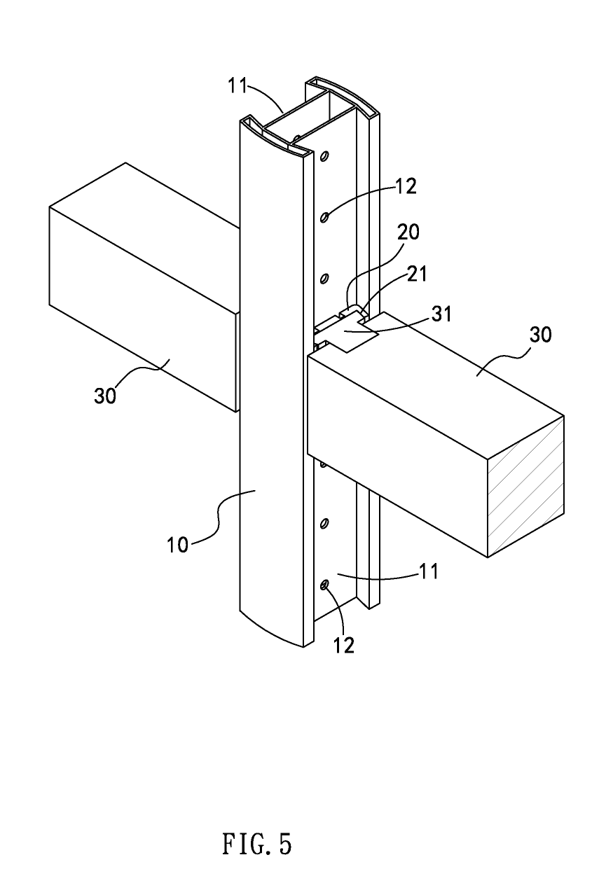

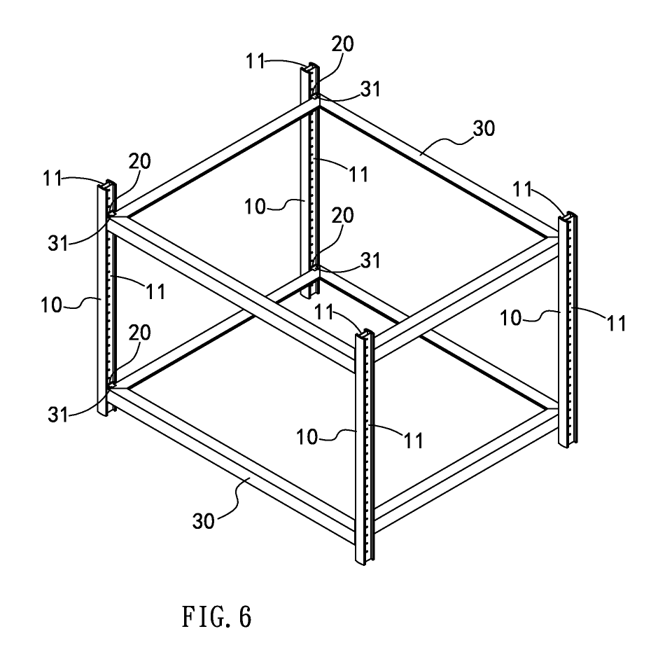

As shown in FIGS. 4 and 5, since the plural connectors 20 are retained in one of the two first retaining slots 11 on one of the two symmetrical side of each longitudinal part 10, and plural engaging blocks 31 of the plurality of horizontal parts 30 are fixed in one of the two symmetrical side of each longitudinal part 10. Thereafter, the plural engaging blocks 31 of the plurality of horizontal parts 30 are retained in the other of the two first retaining slots 11 on the other of the two symmetrical side of each longitudinal part 10 by using the plural connectors 20, thus connecting the plurality of horizontal parts 30 with each longitudinal part 10 by ways of the plural connectors 20.

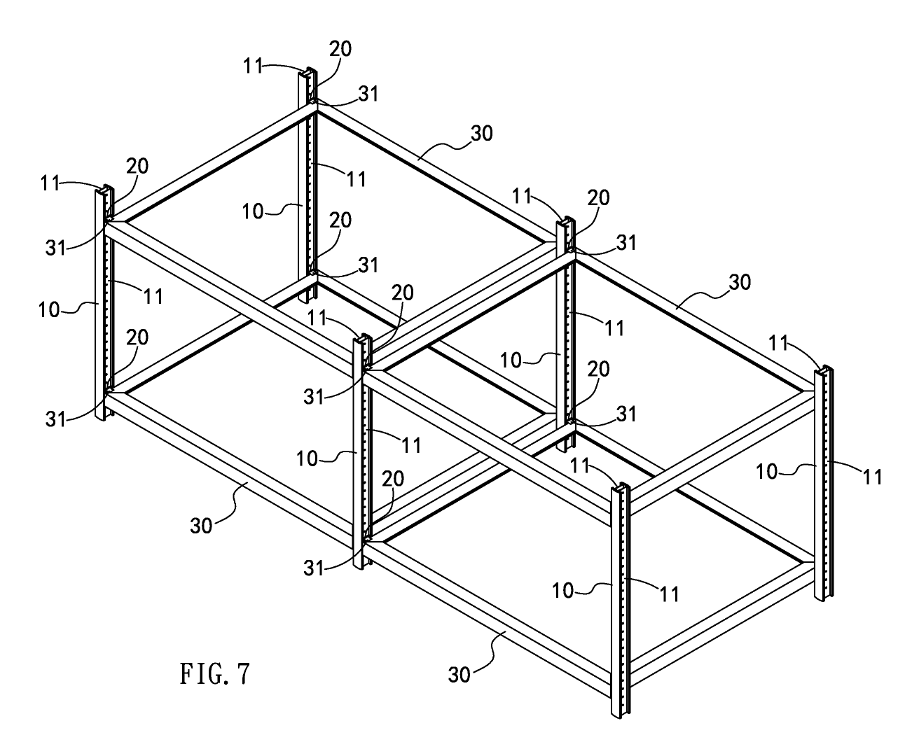

As illustrated in FIGS. 6 and 7, the plurality of horizontal parts 30 are connected with the plurality of longitudinal connecting parts 10 to form a rectangular frame, wherein four engaging blocks 31 are retained in four upper ends of four first retaining slots 11 on four inner sides of four longitudinal parts 10 by using four connectors 20, and four engaging blocks 31 are retained in four lower ends of the four first retaining slots 11 on the four inner sides of the four longitudinal parts 10 by using another four connectors 20, thus forming the rectangular frame.

Thereby, the quick connecting structure of the preset invention can connect plural rectangular frames quickly and easily by means of the plurality of longitudinal connecting parts 10, the plural connectors 20, and the plurality of horizontal parts 30.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A quick connecting structure comprising:
a plurality of longitudinal parts, each including two symmetrical side surfaces on which two first retaining slots are defined, each first retaining slot being formed in a dovetail shape and having a plurality of positioning holes equidistantly formed thereon;
plural connectors, each being formed in a dovetail shape to correspond to each longitudinal part and including a second retaining slot formed on a front surface thereof and in a dovetail shape, two parallel recesses defined on a rear surface thereof, a fixing portion defined between the two parallel recesses, two flexible moving portions formed on two sides thereof, and two coupling segments for coupling the fixing portion and the two flexible moving portions, the fixing portion having plural posts for retaining with the plurality of positioning holes;
a plurality of horizontal parts, each including two engaging blocks retained in two sides thereof, and each engaging block having an insertion extending from one side thereof and an engagement seat joining with the insertion, and the engagement seat being formed in a dovetail shape to correspond to the second retaining slot.

2. The quick connecting structure as claimed in claim 1, wherein each longitudinal part is a hollow column and is extruded from aluminum material, and each longitudinal part includes a rectangular cross section.

3. The quick connecting structure as claimed in claim 2, wherein each longitudinal part includes two opposite arcuate surfaces.

4. The quick connecting structure as claimed in claim 1, wherein each connector is made of plastic material.

5. The quick connecting structure as claimed in claim 1, wherein the plural connectors are retained in one of the two first retaining slots on one of the two symmetrical side of each longitudinal part, and plural engaging blocks of the plurality of horizontal parts are fixed in one of the two symmetrical side of each longitudinal part.

6. The quick connecting structure as claimed in claim 5, wherein the plural engaging blocks of the plurality of horizontal parts are retained in the other of the two first retaining slots on the other of the two symmetrical side of each longitudinal part by using the plural connectors, thus connecting the plurality of horizontal parts with each longitudinal part by ways of the plural connectors.

7. The quick connecting structure as claimed in claim 1, wherein the plurality of horizontal parts are connected with the plurality of longitudinal connecting parts to form a rectangular frame.

8. The quick connecting structure as claimed in claim 7, wherein four engaging blocks are retained in four upper ends of four first retaining slots on four inner sides of four longitudinal parts by using four connectors, and four engaging blocks are retained in four lower ends of the four first retaining slots on the four inner sides of the four longitudinal parts by using another four connectors, thus forming the rectangular frame.
